(19) United States
(12) Patent Application Publication
(10) Pub. No.: US 2024/0144166 A1
(43) Pub. Date: May 2, 2024

(54) MANAGEMENT METHOD AND MANAGEMENT APPARATUS

(71) Applicant: TOYOTA JIDOSHA KABUSHIKI KAISHA, Toyota-shi (JP)

(72) Inventors: Motohiro NAKAMURA, Okazaki-shi (JP); Toshiki KASHIWAKURA, Ota-ku (JP); Yosuke TOGAMI, Nagoya-shi (JP); Yusuke KOBAYASHI, Ota-ku (JP); Seii SAI, Yokohama-shi (JP); Tsuyoshi OKADA, Nagoya-shi (JP); Naoko YOKOYAMA, Minato-ku (JP); Keishi KINOSHITA, Chiyoda-ku (JP)

(73) Assignee: TOYOTA JIDOSHA KABUSHIKI KAISHA, Toyota-shi (JP)

(21) Appl. No.: 18/496,922

(22) Filed: Oct. 30, 2023

(30) Foreign Application Priority Data
Nov. 1, 2022 (JP) 2022-175749

(51) Int. Cl. G06Q 10/0835

(52) U.S. Cl. CPC G06Q 10/08355

(57) ABSTRACT

A management method includes determining, by a management apparatus, an acceptable range of a delivery time based on a delivery condition of goods ordered from a store, and determining, by the management apparatus based on the acceptable range of the delivery time and vehicle classification data on a vehicle that delivers goods, goods to be loaded into the vehicle.

### CROSS-REFERENCE TO RELATED APPLICATION

This application claims priority to Japanese Patent Application No. 2022-175749, filed on Nov. 1, 2022, the entire contents of which are incorporated herein by reference.

### TECHNICAL FIELD

The present disclosure relates to a management method and a management apparatus.

### BACKGROUND

A method in which a vehicle routing problem and the package shapes of packages are calculated at the same time to increase a loading rate in a delivery plan and reduce a travel distance is known (see, for example, Patent Literature (PTL) 1).

### CITATION LIST

### Patent Literature

PTL 1: JP 2020-173789 A

### SUMMARY

The overall efficiency of delivery work by vehicle is required to be improved.

It would be helpful to improve the overall efficiency of delivery work.

A management method according to an embodiment of the present disclosure includes determining, by a management apparatus, an acceptable range of a delivery time based on a delivery condition of goods ordered from a store. The management method includes determining, by the management apparatus based on the acceptable range of the delivery time and vehicle classification data on a vehicle that delivers goods, goods to be loaded into the vehicle.

A management apparatus according to an embodiment of the present disclosure includes a controller. The controller determines an acceptable range of a delivery time based on a delivery condition of goods ordered from a store. The controller determines, based on the acceptable range of the delivery time and vehicle classification data on a vehicle that delivers goods, goods to be loaded into the vehicle.

According to a management method of an embodiment of the present disclosure, the overall efficiency of delivery work by vehicle can be improved.

### BRIEF DESCRIPTION OF THE DRAWINGS

In the accompanying drawings:

FIG. 1 is a block diagram illustrating an example configuration of a management system according to an embodiment; and

FIG. 2 is a flowchart illustrating an example procedure of a management method according to an embodiment.

### DETAILED DESCRIPTION

### (Example Configuration of Management System 1)

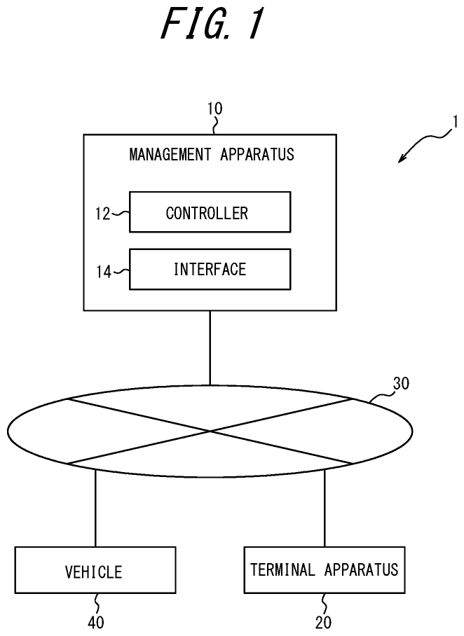

As illustrated in FIG. 1, a management system 1 according to an embodiment includes a management apparatus 10 and a vehicle 40. The vehicle 40 transports goods to be delivered to a store. The vehicle 40 is also referred to as a delivery vehicle. The management apparatus 10 manages operations of the vehicle 40 so as to increase the efficiency of delivery of goods. The management apparatus 10 determines goods to be loaded into the vehicle 40 so as to increase the efficiency of delivery of goods. Information regarding the goods to be loaded into the vehicle 40 is also referred to as goods information.

The management system 1 further includes, but is not required to include, a terminal apparatus 20. The terminal apparatus 20 may be mounted in the vehicle 40 or may be carried by a driver of the vehicle 40. The terminal apparatus 20 may be configured to notify a worker who loads packages into the vehicle 40 or the driver of the vehicle 40 of the goods information determined by the management apparatus 10. The terminal apparatus 20 may be installed in the store, or may be carried by a person in charge of ordering goods or in charge of inventory management of goods in the store. An example configuration of the management system 1 will be described below.

### <Management Apparatus 10>

The management apparatus 10 includes a controller 12 and an interface 14.

The controller 12 controls at least one component of the management apparatus 10. The controller 12 may be configured to include at least one processor. The “processor” may include a general purpose processor, a dedicated processor specialized for specific processing, or the like in the present embodiment, but not limited to these. The controller 12 may be configured to include at least one dedicated circuit. The dedicated circuit may include, for example, a field-programmable gate array (FPGA) or an application specific integrated circuit (ASIC). The controller 12 may be configured to include the dedicated circuit instead of the processor, or may be configured to include the dedicated circuit along with the processor.

The management apparatus 10 may further include a memory. The memory is a semiconductor memory, a magnetic memory, an optical memory, or the like, for example, but not limited to these. The memory may function, for example, as a main memory, an auxiliary memory, or a cache memory. The memory may include an electromagnetic storage medium, such as a magnetic disk. The memory may include a non-transitory computer readable medium. The memory stores any information to be used for operations of the management apparatus 10. For example, the memory may store a system program, an application program, or the like. The memory may be included in the controller 12.

The interface 14 outputs information, data, or the like from the controller 12 to an external apparatus, and inputs information, data, or the like acquired from the external apparatus to the controller 12. The interface 14 may include a communication module that is configured communicably with the external apparatus, such as the vehicle 40 or the terminal apparatus 20, via a network 30. The communication module may be, for example, compliant with a mobile communication standard, such as the 4th Generation (4G) standard or the 5th Generation (5G) standard. The communication module may be compliant with a communication standard, such as a Local Area Network (LAN). The communication module may be compliant with a wired or wireless communication standard. The communication module may be compatible with various communication standards, including but not limited to these. The interface 14 may be configured to be able to connect to a communication module.

The interface 14 may be configured to include an input device that accepts input of information, data, or the like from a user. The input device may be configured to include, for example, a touch panel, a touch sensor, or a pointing device such as a mouse. The input device may be configured to include a physical key. The input device may be configured to include an audio input device, such as a microphone.

The interface 14 may be configured to include an output device that outputs information, data, or the like to the user. The output device may include, for example, a display device that outputs visual information, such as images, letters, or graphics. The display device may be configured to include, for example, a Liquid Crystal Display (LCD), an organic or inorganic Electro-Luminescent (EL) display, a Plasma Display Panel (PDP), or the like. The display device is not limited to the above displays and may be configured to include various other types of displays. The display device may be configured to include a light emitting device, such as a Light Emitting Diode (LED) or a Laser Diode (LD). The display device may be configured to include various other devices. The output device may include, for example, an audio output device, such as a speaker, that outputs audio information, such as voice. The output device is not limited to the above examples and may include various other devices.

The management apparatus 10 may include a single server apparatus, or multiple server apparatuses capable of communicating with each other.

### <Vehicle 40>

The vehicle 40 includes a vehicle body and a drive unit. The vehicle is configured to load, into the vehicle body, articles to be delivered. The vehicle 40 may further include a controller that controls the drive unit. The vehicle 40 may further include a positional information detector that acquires positional information on the vehicle 40 itself. The vehicle 40 may output the positional information on the vehicle 40 itself to the management apparatus 10. The positional information detector may be configured to include a receiver compliant with a satellite positioning system. The receiver compliant with the satellite positioning system may include, for example, a Global Positioning System (GPS) receiver or the like.

The number of vehicles 40 managed by the management system 1 may be two or more. The vehicle 40 may be configured to be operated by a driver or may be configured to travel by automated driving. When being operated by the driver, the vehicle 40 may include an in-vehicle apparatus, such as a navigation apparatus, that acquires an operation schedule from the management apparatus 10 and notifies the driver of the operation schedule. The operation schedule may be notified to the driver by the terminal apparatus described below. When traveling by automated driving, the vehicle 40 may travel based on an operation schedule acquired from the management apparatus 10.

### <Terminal Apparatus 20>

The terminal apparatus 20 may be configured to include one or more processors or one or more dedicated circuits. The terminal apparatus 20 may be configured to include a memory. The memory of the terminal apparatus 20 may be configured to be identical or similar to the memory of the management apparatus 10. The terminal apparatus 20 may be configured to include an interface or a communication module. The interface or communication module of the terminal apparatus 20 may be configured to be identical or similar to the interface or communication module of the management apparatus 10, respectively.

The terminal apparatus 20 may be configured to include an input device that accepts input of information, data, or the like from a user. The input device may be configured to include the various devices described as the interface 14. The terminal apparatus 20 may be configured to include an output device that outputs information, data, or the like to the user. The output device may be configured to include the various devices described as the interface 14.

The number of terminal apparatuses 20 included in the management system 1 is not limited to one and may be two or more. The terminal apparatus may be configured as a mobile terminal, such as a smartphone or a tablet, or a Personal Computer (PC), such as a notebook PC or a tablet PC. The terminal apparatus 20 is not limited to the above examples and may be configured to include various devices.

### (Example Operations of Management System 1)

In the management system 1 according to the present embodiment, the controller 12 of the management apparatus 10 determines goods to be loaded into the delivery vehicle. Example operations for determining goods to be loaded into the delivery vehicle will be described below.

### <Determination of Acceptable Range of Delivery Time>

In the management system 1, a store orders goods. The store may order the goods via the terminal apparatus 20. The controller 12 of the management apparatus 10 accepts orders from the store. Information accepting the orders from the store is also referred to as order information. The order information includes information regarding the goods ordered from the store. The order information includes delivery conditions of the goods ordered from the store.

The delivery conditions of the goods may include information designating a time or a time period at which the goods are to be delivered to the store. The delivery conditions of the goods may include attributes of the goods. The attributes of the goods may include, for example, an expiration date, such as a sell-by date or a consume-by date, of the goods. The attributes of the goods may include a time period during which demand for the goods is high. For example, in a case in which the goods are packed meals or sandwiches, the time period during which demand for the goods is high can be a specific time period, such as between 11:00 a.m. and 1:00 p.m. The attributes of the goods may include storage temperature of the goods. The attributes of the goods may include whether the goods are refrigerated goods or frozen goods.

The delivery conditions of the goods may include information on a destination of the goods, i.e., information on the store that has ordered and is to receive the goods. The information on the store may include, for example, the business type of the store. The business type of the store may be categorized, for example, as a large or small supermarket or a convenience store. The information on the store may include, for example, the size of a stockroom of the store. The information on the store may include whether the arriving goods are to be housed once in the stockroom or displayed directly on store shelves. The information on the store may include, for example, the number of personnel available for goods receiving work when the goods arrive at the store. The information on the store may include information on the predicted number of personnel available for goods receiving work, for each time period during which the goods arrive.

The controller 12 determines, based on the delivery conditions of the goods ordered from the store, an acceptable range of a delivery time. The acceptable range of the delivery time can correspond to the range of a time period during which the delivery vehicle is allowed to arrive at the store. For example, the controller 12 may determine the acceptable range of the delivery time within the range of the time period that is designated in the delivery conditions as a time period at which the goods are to be delivered to the store. The controller 12 may determine the acceptable range of the delivery time in a time period prior to the time period during which demand for the goods is high. The controller 12 may determine the acceptable range of the delivery time in a time period that is at least a predetermined amount of time prior to the expiration date, such as the sell-by date or the consume-by date, of the goods. The controller 12 may determine the acceptable range of the delivery time in a time period during which a predetermined number or more of personnel available for goods receiving work at the store can be secured. In a case in which the delivered goods are displayed directly on store shelves, the controller 12 may determine the acceptable range of the delivery time in a time period during which the store is not crowded. In other words, the controller 12 may determine the acceptable range of the delivery time in a time period during which the number of customers in the store is less than a predetermined number.

<Determination of Goods to be Loaded into Delivery Vehicle>

The controller 12 acquires vehicle classification data on the vehicle 40 as the delivery vehicle. The vehicle classification data on the vehicle 40 may include, for example, a classification based on the body size of the vehicle 40. The vehicle 40 may be classified according to the body size, for example, as very small, small, medium, large, or very large. The vehicle classification data on the vehicle 40 may include the external size, weight, or the like of the vehicle 40. The vehicle classification data may include the capacity, size, position, or the like of a luggage carrier. The vehicle classification data may include specifications of the luggage carrier. The specifications of the luggage carrier may include a controlled range of temperature for space in which packages are loaded. The specifications of the luggage carrier may include, for example, specifications that allow loading of refrigerated goods or frozen goods, or the like. The vehicle classification data may include the minimum turning radius of the vehicle 40, the difference between inner or outer wheels thereof, or the like. The vehicle classification data may include the position of the center of gravity of the vehicle 40, or the like. The position of the center of gravity of the vehicle 40 is determined from the positions of heavy components such as an engine or a battery mounted on the vehicle 40. The vehicle classification data is information that does not change over time. The controller 12 may store the vehicle classification data on each vehicle 40 in the memory in advance.

The controller 12 determines, based on the acceptable range of the delivery time and the vehicle classification data on the delivery vehicle, goods to be loaded into the delivery vehicle. The controller 12 may generate goods information regarding the goods to be loaded into the delivery vehicle. The controller 12 may output the goods information to the terminal apparatus 20 or the like, or notify a user of the goods information.

For example, the controller 12 may determine goods to be loaded into the delivery vehicle so that the single delivery vehicle is loaded with goods that are designated to be delivered at the same time period. The controller 12 may determine goods to be loaded into the delivery vehicle so that the single delivery vehicle is loaded with goods at the same storage temperature.

In a case in which there is a vacant space in the delivery vehicle when the single delivery vehicle is loaded with goods that are designated to be delivered at a particular time period, for example, the controller 12 may determine to additionally load other goods into the delivery vehicle. The controller 12 may determine, as the goods to be additionally loaded, goods for which no time periods for delivery are designated or wide ranges are designated as time periods for delivery.

When the acceptable range of the delivery time is narrow, the controller 12 may determine goods to be loaded into the delivery vehicle with giving priority to the arrival of the delivery vehicle at the store within the acceptable range. For example, in a case in which the ordered goods are late in arriving, the controller 12 may determine, as goods to be loaded, goods that can arrive and be loaded into the delivery vehicle by a departure time of the delivery vehicle. In a case in which the acceptable range of the delivery time is wide, the controller 12 may determine goods to be loaded into the delivery vehicle so that the delivery vehicle waits for the ordered goods to arrive and is loaded with the ordered goods.

After the controller 12 has determined goods to be loaded into the delivery vehicle, the status of arrival of the goods scheduled to be loaded into the delivery vehicle can change. Also, the goods scheduled to be loaded into the delivery vehicle can become impossible to ship. When the status of the goods to be loaded has changed, the controller 12 may modify the acceptable range of the delivery time and/or the goods to be loaded into the delivery vehicle. In other words, the controller 12 may modify the acceptable range of the delivery time and/or the goods to be loaded into the delivery vehicle based on a change in the status of the goods to be loaded, such as a change in items or quantities of goods that can be shipped to the store, or a change in time when the goods become available for shipment.

The controller 12 may determine goods to be loaded into the delivery vehicle so that the acceptable range of the delivery time conforms to the order information. The controller 12 may determine the acceptable range of the delivery time so that the ordered goods can be loaded into the delivery vehicle. The controller 12 may widen an acceptable range of the difference between the ordered goods and the goods to be actually loaded into the delivery vehicle, the narrower the acceptable range of the delivery time with respect to the delivery time or time period designated in the order information. In a case in which the acceptable range of the delivery time is narrow, strict adherence to an operation schedule for the delivery vehicle is a priority. Therefore, the controller 12 may determine goods to be loaded into the delivery vehicle so that the delivery vehicle keeps the operation schedule, even allowing for shortages of the goods to be loaded into the delivery vehicle relative to the ordered goods. By adhering to the operation schedule for the delivery vehicle, the delivered goods can be received smoothly. As a result, the overall efficiency of delivery work can be increased.

The controller 12 may modify the order from the store to match goods to be loaded into the delivery vehicle. Specifically, the controller 12 may cancel a portion of the order and reduce the quantity of the order when the quantity of goods that can be loaded into the delivery vehicle is less than the quantity ordered. In a case in which there is an item that cannot be loaded into the delivery vehicle, the controller 12 may cancel the order for that item. The controller 12 may notify the store of the cancellation of at least a portion of the order. The controller 12 may also notify the store of possible shortages due to widening the acceptable range of the difference between the ordered goods and the goods actually loaded into the delivery vehicle. Store personnel can order other goods or place an order with another delivery company based on the possibility of the order cancellation or shortages. In this way, goods to be loaded into the delivery vehicle can be determined taking into account the circumstances of both a receiver and a deliverer of the goods.

### <Direction for Operation>

Upon determining the acceptable range of the delivery time and the goods to be loaded into the delivery vehicle, the controller 12 may determine an operation schedule for the delivery vehicle so that the loaded goods can be delivered to the store within the determined acceptable range of the delivery time. In a case in which the status of the goods to be loaded has changed, the controller 12 may modify the determined operation schedule according to the change in status. The controller 12 may direct the delivery vehicle to operate based on the determined or modified operation schedule.

### <Example Procedure for Management Method>

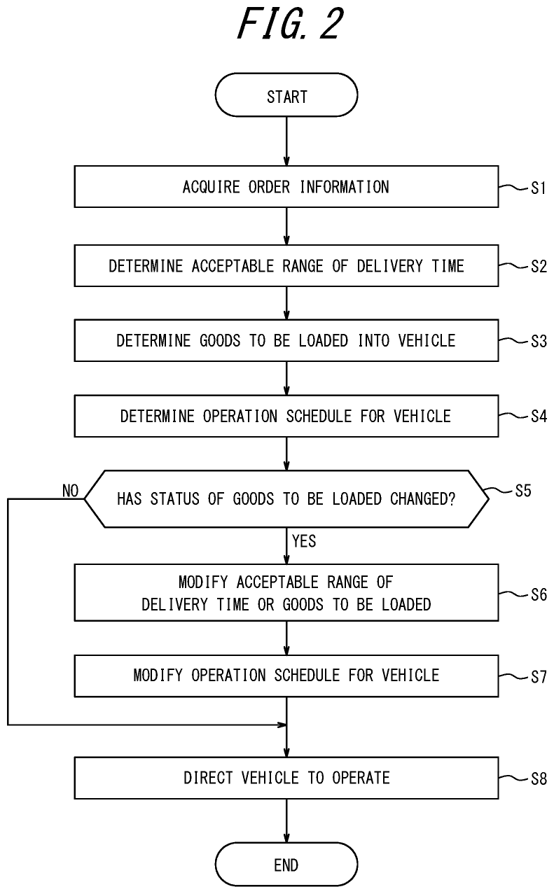

As described above, in the management system 1 according to the present embodiment, the controller 12 of the management apparatus 10 may perform a management method including, for example, the flowchart procedure illustrated in FIG. 2 to determine goods to be loaded into the delivery vehicle and to direct operations of the delivery vehicle. The management method may be implemented as a management program to be executed by the controller 12. The management program may be stored on a non-transitory computer readable medium.

The controller 12 acquires order information (step S1). The controller 12 determines, based on the order information, an acceptable range of a delivery time (step S2). The controller 12 determines, based on the order information, goods to be loaded into the delivery vehicle (step S3). The controller 12 determines an operation schedule for the delivery vehicle so that the delivery vehicle can deliver the loaded goods to a store within the determined acceptable range of the delivery time (step S4).

The controller 12 determines whether the status of the goods that have been determined to be loaded has changed (step S5). When the status of the goods has changed (step S5: YES), the controller 12 modifies, based on the changed status, the acceptable range of the delivery time and/or the goods to be loaded into the delivery vehicle (step S6). The controller 12 modifies the operation schedule for the delivery vehicle (step S7). The controller 12 directs the delivery vehicle to operate on the operation schedule modified in the process of step S7 (step S8). When the status of the goods has not changed (step S5: NO), the controller 12 proceeds to the process of step S8 and directs the delivery vehicle to operate on the operation schedule determined in the process of step S4. After performing the process of step S8, the controller 12 ends the execution of the procedure in the flowchart of FIG. 2. The procedure of the management method is not limited to the example procedure in the flowchart in FIG. 2 and may include other processes. Some of the processes in the example procedure in FIG. 2 may be omitted or the order may be interchanged.

### SUMMARY

As described above, according to the management system 1 and the management apparatus 10 according to the present embodiment, goods to be loaded into the vehicle 40 can be determined taking into account an acceptable range of a delivery time. This can increase the efficiency of loading goods into the vehicle 40. As a result, the efficiency of delivery of goods using the vehicle 40 can be improved. In other words, the overall efficiency of delivery work can be increased.

In addition, the goods to be loaded into the vehicle 40 can be modified according to a change in the status of the goods. Thereby, the circumstances of both a receiver and a deliverer of the goods in the delivery work can be taken into account. As a result, the overall efficiency of the delivery work can be increased. This also can keep an operation schedule. By adhering to the operation schedule, the delivered goods can be received smoothly. In other words, the efficiency of goods receiving work can be improved. As a result, the overall efficiency of the delivery work can be increased.

In addition, the acceptable range of the delivery time can be determined based on the business type of a store. Thereby, the delivered goods can be received smoothly. In other words, the efficiency of goods receiving work can be improved. As a result, the overall efficiency of the delivery work can be increased.

While an embodiment of the present disclosure has been described with reference to the drawings and examples, it is to be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. A management method performed by a management apparatus, the management method comprising:
determining an acceptable range of a delivery time based on a delivery condition of goods ordered from a store; and
determining, based on the acceptable range of the delivery time and vehicle classification data on a vehicle that delivers goods, goods to be loaded into the vehicle.

2. The management method according to claim 1, further comprising, the narrower the acceptable range of the delivery time, widening an acceptable range of a difference between an order from the store and the goods to be loaded into the vehicle that delivers goods to the store.

3. The management method according to claim 1, further comprising modifying the acceptable range of the delivery time, the goods to be loaded into the vehicle, and/or an order from the store, according to a change in a circumstance regarding the goods to be loaded into the vehicle.

4. The management method according to claim 2, further comprising modifying the acceptable range of the delivery time, the goods to be loaded into the vehicle, and/or the order from the store, according to a change in a circumstance regarding the goods to be loaded into the vehicle.

5. The management method according to claim 1, wherein the delivery condition of the goods includes a business type of the store.

6. The management method according to claim 2, wherein the delivery condition of the goods includes a business type of the store.

7. The management method according to claim 3, wherein the delivery condition of the goods includes a business type of the store.

8. The management method according to claim 4, wherein the delivery condition of the goods includes a business type of the store.

9. A management apparatus comprising a controller configured to:
determine an acceptable range of a delivery time based on a delivery condition of goods ordered from a store; and
determine, based on the acceptable range of the delivery time and vehicle classification data on a vehicle that delivers goods, goods to be loaded into the vehicle.

10. The management apparatus according to claim 9, wherein the controller is further configured to, the narrower the acceptable range of the delivery time, widen an acceptable range of a difference between an order from the store and the goods to be loaded into the vehicle that delivers goods to the store.

11. The management apparatus according to claim 9, wherein the controller is further configured to modify the acceptable range of the delivery time, the goods to be loaded into the vehicle, and/or an order from the store, according to a change in a circumstance regarding the goods to be loaded into the vehicle.

12. The management apparatus according to claim 10, wherein the controller is further configured to modify the acceptable range of the delivery time, the goods to be loaded into the vehicle, and/or the order from the store, according to a change in a circumstance regarding the goods to be loaded into the vehicle.

13. The management apparatus according to claim 9, wherein the delivery condition of the goods includes a business type of the store.

14. The management apparatus according to claim 10, wherein the delivery condition of the goods includes a business type of the store.

15. The management apparatus according to claim 11, wherein the delivery condition of the goods includes a business type of the store.

16. The management apparatus according to claim 12, wherein the delivery condition of the goods includes a business type of the store.
